(19) United States
(12) Patent Application Publication
(10) Pub. No.: US 2019/0042395 A1
(43) Pub. Date: Feb. 7, 2019

(54) SOURCE CODE PROFILING THROUGH ENHANCED MAPPING

(71) Applicant: Intel Corporation, Santa Clara, CA (US)

(72) Inventors: Li Tian, Bellevue, WA (US); Varun K. Venkatesan, Bellevue, WA (US); Richard Kozlak, Kirkland, WA (US); Priyanka Hegde, Bellevue, WA (US); Vincent Zimmer, Federal Way, WA (US); Rodolfo Esteves Jaramillo, Sammamish, WA (US); Xiangyang Guo, Bellevue, WA (US)

(21) Appl. No.: 16/145,399

(22) Filed: Sep. 28, 2018

(51) Int. Cl. G06F 11/36; G06F 11/34; G06F 8/41; G06F 8/30

(52) U.S. Cl. CPC G06F 11/3612; G06F 11/3466; G06F 11/3624; G06F 2201/865; G06F 11/3419; G06F 8/41; G06F 8/30; G06F 11/3656

(57) ABSTRACT

Systems, apparatuses and methods may provide for technology that may profile a first low-level language code to identify a first latency of a first portion of the first low-level language code. The technology may map the first portion to a source portion of a source code based on an identification that the first portion is a low-level language code representation of the source portion. The source code may be a high-level language code. The technology may associate the first latency with the source portion based on the mapping.

### TECHNICAL FIELD

Embodiments generally relate to accurate latency and analysis measurements. More particularly, embodiments relate to one or more profilers that provide an accurate measurement of the latency of source code.

### BACKGROUND

A developer may analyze source code to identify hotspots and bugs in the source code. Such analysis may become difficult. For example, the source code may be a high-level language code. A high-level language code may be a code written with natural language elements such as C# or Java with a strong abstraction from the details of the computer, such as the underlying microarchitectures. The source code may be compiled into an intermediate language (e.g., bytecode), and then into a low-level language code (e.g., machine code or assembly code) that is executable by the microarchitecture of a computer. A low-level language code may be a code that provides little or no abstraction from a computer's instruction set architecture (ISA) or microarchitecture. For example, the low-level language code may include commands or functions in a language that maps closely to processor instructions, and may be assembly language instructions that may be conceptually machine code. Thus, the high-level language code may not consider the underlying computer architecture and include instructions abstracted away from the computing architecture, whereas the low-level language code may be heavily mapped to a computer architecture and include instructions specific to the computing architecture.

As such, a high-level language code may be compiled into different low-level language codes depending on the computer architectures. Therefore, accurate latency measurements of the source code may be difficult since the same source code may be implemented differently depending on the computer architecture. Thus, a developer may inaccurately ascertain the latency of a computer program only in relation to a single computing architecture.

### BRIEF DESCRIPTION OF THE DRAWINGS

The various advantages of the embodiments will become apparent to one skilled in the art by reading the following specification and appended claims, and by referencing the following drawings, in which:

FIG. 1A is a block diagram of an example of a system architecture according to an embodiment;

FIG. 1B is an example of a graphical user interface showing latency measurements relative to source and assembly code according to an embodiment;

FIG. 2 is a flowchart of an example of a method of hotspot analysis according to an embodiment;

FIG. 3 is a flowchart of an example of a method of managing source code analysis according to an embodiment;

FIG. 4 is a flowchart of an example of a method of a function-as-a-service source code tuning according to an embodiment;

FIG. 5 is an example of a graphical user interface showing a source code filename according to an embodiment;

FIG. 6A is an example of a symbolic database according to an embodiment;

FIG. 6B is an example of physical tables according to an embodiment;

FIG. 7 is a block diagram of an example of a computing system according to an embodiment;

FIG. 8 is an illustration of an example of a semiconductor apparatus according to an embodiment;

FIG. 9 is a block diagram of an example of a processor according to an embodiment; and

FIG. 10 is a block diagram of an example of a multi-processor based computing system according to an embodiment.

### DESCRIPTION OF EMBODIMENTS

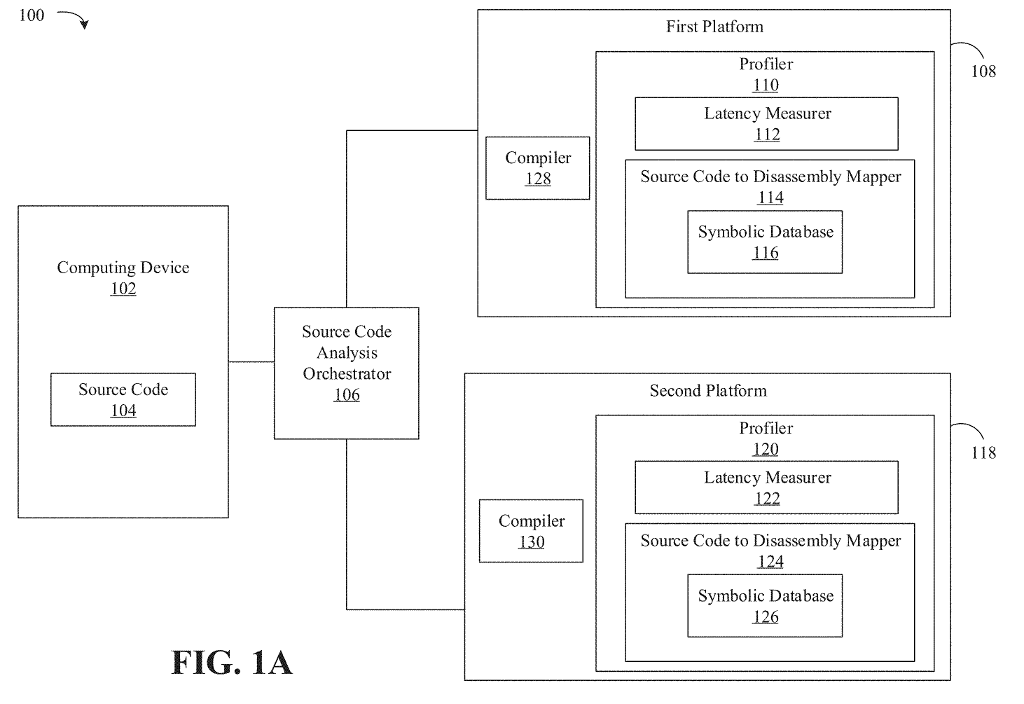

FIG. 1 illustrates an enhanced latency analysis architecture 100 that offers source level tuning capability via function-as-a-service (FaaS). For example, the latency analysis architecture 100 may include a FaaS architecture including source code analysis orchestrator 106, a first platform 108 and a second platform 118. A user (e.g., a programmer or developer), may develop a source code 104 (i.e., a high-level language that is independent of a particular type of micro-architecture or computer). The source code 104 may be written and tested through an integrated development environment (IDE). The source code analysis orchestrator 106 may determine whether a trigger is received. The trigger may cause the source code analysis orchestrator 106 to initiate an analysis of the source code 104 to identify “hot spots.” Briefly, a hot spot may be a portion of the source code 104 in which a high proportion of executed instructions occur or where more time is spent during the program's execution relative to other portions of the source code 104 (i.e., have a higher latency). The trigger may include, for example, saving the source code 104, a size of the source code 104 reaching a predetermined number of lines of code, a button of the IDE being actuated, “new push to the code base” command, a “new Dynamic Link Library, and program database” generation and so forth.

As described below in greater detail, the source code analysis orchestrator 106 may operate in conjunction with the first and second platforms 108, 118 to identify hotspots of the source code 104, and identify the portions of the source code 104 that generated the hotspots. Doing so provides an enhanced understanding of the source code 104. In contrast, some conventional situations may generate a lower-level language (e.g., assembly code) from the source code. Due to a lack of source level mapping, only portions of the lower-level language are identified as causing the hotspots, leaving the programmer unaware of the original source code that caused the hotspots. Performance tuning tips and hotspots that are only identified at the assembly code level may typically only be useful for compiler developers. In contrast, some embodiments provide tuning tips and hotspot analysis at the source code level, and thus may be efficiently utilized by application (e.g., .NET) developers and compiler developers.

Further, both the first and second platforms 108, 118 may each undertake an independent hotspot analysis of the source code 104 to provide an enhanced understanding of source code 104 execution. For example, the source code 104 may generate a hotspot on certain architectures but not on other architectures. As one possibility, the same source code 104 may use general registers/xmm/ymm on different generations of microarchitectures, and specialized registers on other architectures. Such distinctions across architectures may generate unique hotspots for the particular architecture, as well as unique assembly code. By implementing the hotspot analysis across different architectures, a more accurate measurement and understanding may be achieved, to therefore enhance future generations of the source code 104.

On the other hand, if only a local machine, such as the computing device 102 (e.g., a user device), was used to execute profiling of the source code 104, the programmer may lack the ability to determine whether the local machine and a deploy-machine will have the same assembly, and therefore lack the ability to identify hotspots and/or bugs on the deploy-machine. Thus, the programmer may not be able to fine tune the source code 104 for the deploy-machine. Some of the embodiments described herein remedy this deficiency by conducting hotspot analysis on multiple micro-architectures that resemble possible deploy-machines.

Further, the source code analysis orchestrator 106, the first platform 108 and the second platform 118 may be considered remote to the computing device 102, and/or constitute a FaaS cloud environment that may implement the source code 104 at a deploy time. The deploy time may be when the developer has finalized the source code 104 (debugged) and the source code 104 is to execute live and utilized in real-world services. Since the same FaaS cloud environment that will deploy the source code 104 is used to profile the source code 104, the developer may have an accurate understanding of the latencies of the source code 104 during deployment.

The source code analysis orchestrator 106 may coordinate the analysis of the source code 104 through one or more function calls to the first platform 108 and the second platform 118. For example, the source code analysis orchestrator 106 may determine that a first platform 108 and a second platform 118 may compile and execute the source code 104. The first platform 108 and the second platform 118 may include different microarchitectures (e.g., central processing units, host processors, microcontroller, etc.) from each other to generate different implementations of the source code 104. For example, a compiler 128 may compile the source code 104 into a first machine code on the first platform 108 and generate a symbolic database 116. The first machine code may be conceptually equivalent to a first assembly language code (be equivalents). The symbolic database 116 may be in a Portable PDB (Program Database) format that describes an encoding of debugging information produced by compiler 128, and is consumed by debuggers or profiler tools such as the profiler 110. For example, the symbolic database 116 may be an auxiliary file produced by the compiler 128 to provide other tools, particularly the profiler 110, information about what is in the first assembly language code and how the first assembly language code was produced. The symbolic database 116 may be operating system agnostic (may have cross-platform compatibility to be generated on Windows and Linux).

The source code to disassembly mapper 114 may map a high level-language code to a low-level language code. In detail, the source code 104 (a high-level language code) may be mapped to a disassembly level code (a low-level language code). For example, the source code to disassembly mapper 114 may read the symbolic database 116 to map a particular line of the source code 104 to a correct location in the first assembly language code so that a latency measurer 112 of the profiler 110 may set a breakpoint when measuring the latency of the source code 104. For example, the source code to disassembly mapper 114 may disassemble the first assembly language code into an intermediate language, and link the source code 104 to the first assembly language code through the intermediate language. In some embodiments, the compiler 128 may compile the source code 104 into the bytecode or Intermediate Language (IL), which is then compiled into the first assembly language code that represents a first machine language code. In such embodiments, the source code to disassembly mapper 114 may interpret the symbolic database 116 to map the source code 104 to the bytecode (or Intermediate Language) and map the bytecode to the first assembly language code. Therefore, each line of the first machine code (first assembly language code) may be mapped to corresponding lines of the source code 104. As described, the first assembly language code or the first machine code may be low-level language codes.

The profiler 110 of the first platform 108 may profile the source code 104. For example, the latency measurer 112 may measure the execution (latency measurements of the execution) of the first assembly language code, and associate the measurements with the source code 104. For example, the latency measurer 112 may measure a latency of execution of each portion of the first assembly language code. The latency measurer 112 may then determine a latency of the corresponding lines of the source code 104 and first assembly language code.

The profiler 110 may combine the information from the latency measurer 112 and the source to code disassembly mapper 114 to generate latency measurements in relation to the source code 104. For example, the profiler 110 may generate a latency data structure that includes each line of the source code 104 and a latency of the line. As one example, a particular line of the source code 104 may be mapped to several lines of the first assembly language code. The particular line of the source code 104 may have a total latency that is a summation of each latency of the several lines of the first assembly language code, and the particular line of the source code 104 may therefore be associated with the total latency.

Similarly, the second platform 118 may generate a second assembly language code (second machine code) and a symbolic database 126. The second assembly language code may be different from the first assembly language code. In further detail, the generated first and second assembly codes may be particular to the underlying microarchitectures of the first and second platforms 108, 118.

Similarly, the second platform 118 may include a profiler 120 that includes a latency measurer 122 and source code to disassembly mapper 124. For the sake of brevity, a detailed description of the compiler 130, the profiler 120, the latency measurer 122 and the source code to disassembly mapper 124 will be omitted. It is worth noting however that the compiler 130, profiler 120, the latency measurer 122 and the source code to disassembly mapper 124 operate and are configured similarly to the compiler 128, profiler 110, latency measurer 112 and source code to disassembly mapper 114 described above.

The latency measurer 122 may measure the execution of the second assembly language code. As noted above, the second assembly language code may be different from the first assembly language code. Moreover, the second assembly language code may operate on a different architecture than the first assembly language code. Thus, the latency measurements of the latency measurer 122 may differ from the latency measurements of the latency measurer 112, even for a same line of the source code 104. As described above, the profiler 120 may combine the information from the latency measurer 122 and the source to code disassembly mapper 124 to generate latency measurements in relation to the source code 104. For example, the profiler 120 may generate a latency data structure that includes each line of the source code 104 and a latency of the line.

The profilers 110, 120 may provide the latency measurements to the source code analysis orchestrator 106. For example the profilers 110, 120 may provide the source code 104 and the latencies of each line of the source code 104 (e.g., the latency data structures) to the source code analysis orchestrator 106. The source code analysis orchestrator 106 may in turn average the latency measurements of the profilers. For example, for each line of the source code 104, the source code analysis orchestrator 106 may average the latency measured by the profiler 110 for that line, and the latency measured by the profiler 120 for that line. The source code analysis orchestrator 106 may in turn present the received information, the latencies and hotspots to the computing device 102 for display.

Thus, the user of a computing device 102 may receive dynamic hotspot and latency information indicating the execution of source code 104 across the first and second platforms 108, 118. Such an implementation may allow a more comprehensive and accurate overview of the source code 104, which in turn allows a user to modify the source code 104. In some embodiments, the source code analysis orchestrator 106 may allow provide suggestions to the user, such as modifying specific lines of code or automatically revising some portions of the source code 104 that are identified as being hotspots.

For example, FIG. 1B illustrates a graphical user interface 140. The source code analysis orchestrator 106 may generate the graphical user interface 140 from the latency data received from the first and second platforms 108, 118, and instruct the computing device 102 to present the graphical user interface 140 to a user, for example by displaying the graphical user interface 140.

The graphical user interface 140 may include a source code mapping 142. In the source code mapping 142, a portion of the source code 104, a latency for the first platform 108, a latency the second platform 118 and an average latency of the first platform 108 and the second platform 118 are presented. As illustrated, each line of the source code corresponds to several latencies. Thus, a developer may quickly ascertain an overall performance through the average latency, as well as platform (i.e., architecture) specific latencies for the first and second platforms 108, 118. For example, line 19 (i.e., foreach (var item)), has a latency on the first platform 108 of 835.26 ms, a latency of 698.26 ms on the second platform 118 and an average latency of 766.76 ms. Thus, the developer may quickly ascertain that line 19 is a hotspot, and modify the source code 104 if needed. It is worth noting that the same line of code 19 generates different latencies of the first and second platforms 108, 118 due to the differing underlying architectures.

The graphical user interface 140 further includes an assembly code mapping 144 of the source code 104 that may be used by the source code analysis orchestrator 106 to derive the latencies presented by the source code mapping 142. The assembly code mapping 144 may include assembly code of the first assembly language code of the first platform 108, an address of the first assembly language code, corresponding source code lines, and latencies. In detail, each line of the first assembly code may be associated with a different address and correspond to a line of the source code. For example, source code line 19 corresponds to assembly code “mov ebi, dword” and “mov, dword ptr [r].” The assembly code “mov ebi, dword” has a latency of 373.26, and the assembly code “mov, dword ptr [r]” has a latency of 462 ms. Thus, source code line 19 (i.e., “foreach (var item)”) has a total latency of 835.26 on the first platform 108, which is the summation of the latencies of each line of the assembly code that corresponds to the source code line 19. An assembly code line may be deemed to correspond to the source code line when the assembly code line implements the source code line. For example, a compiler may compile the source code line 19 to assembly code “mov ebi, dword” and “mov, dword ptr [r]” to represent the source code line 19 in assembly language. Thus, the latencies for the first platform 108 presented by the source code mapping 142 may be derived from the assembly code mapping 144.

The graphical user interface 140 further includes an assembly code mapping 146 of the source code 104 of the second platform 118, an address of the second assembly language code generated by the second platform 118, corresponding source code lines, and latencies. Similarly to as above, the latencies for the second platform 118 presented by the source code mapping 142 may be derived by the source code analysis orchestrator 106 from the assembly code mapping 146.

The graphical user interface 140 may further graphically link different lines of code. For example, if the user selects source code line 19 in one or more of the source code mapping 142, the assembly code mapping 144 or the assembly code mapping 146, each latency, assembly code, address and line corresponding to source code line 19 may be highlighted. In some embodiments, the graphical user interface 140 may automatically place a graphical emphasis (e.g., highlighting) on lines that include hotspots, such as each line that corresponds source code line 19.

Thus, the graphical user interface 140 may present the latencies of the first and second platforms 108, 118 in relation to the source code 104. By doing so, an enhanced and global platform perspective (e.g., across different architectures) may be provided to the user. Moreover, enhancing the source code 104 may be less cumbersome and time consuming since a user may quickly understand which lines of code are presenting the highest latencies and on which architectures. The graphical user interface 140 may present more lines of the source code 104 depending on the nature of the user's preferences and display screen size.

Turning back to FIG. 1A, in some embodiments, the first and second platforms 108, 118 may operate with different operating systems. Thus, the source code analysis orchestrator 106 may derive hotspot data for the source code 104 across different operating systems.

In some embodiments, the first platform 108 and/or second platform 118 may build the source code 104. In such embodiments, the computing device 102 may be omitted. In some embodiments, the first and second platforms 108, 118 are collocated at a same node, and in some embodiments, the first and second platforms 108, 118 are located at different nodes (e.g., servers, mobile devices, tablets) from each other.

Thus, the enhanced architecture 100 may leverage the convenience of FaaS (Function as a Service) and several performance tools/architectures as well as a debug format information, such as symbolic databases 116, 126, to offer application developers the ability to tune applications for various architectures. That is, the architecture 100 may implement a universal FaaS based tuning solution. Combined with performance tools and FaaS mechanisms, the architecture 100 may leverage the symbolic databases 116, 126 (which may be traditional PDB, Portable PDB or another debug information format) to quickly achieve application source code to disassembly level mapping and offer performance tuning tips to the application developers to tune their code. For example, for .NET Core developers, the architecture 100 may generate performance tuning tips for C# code.

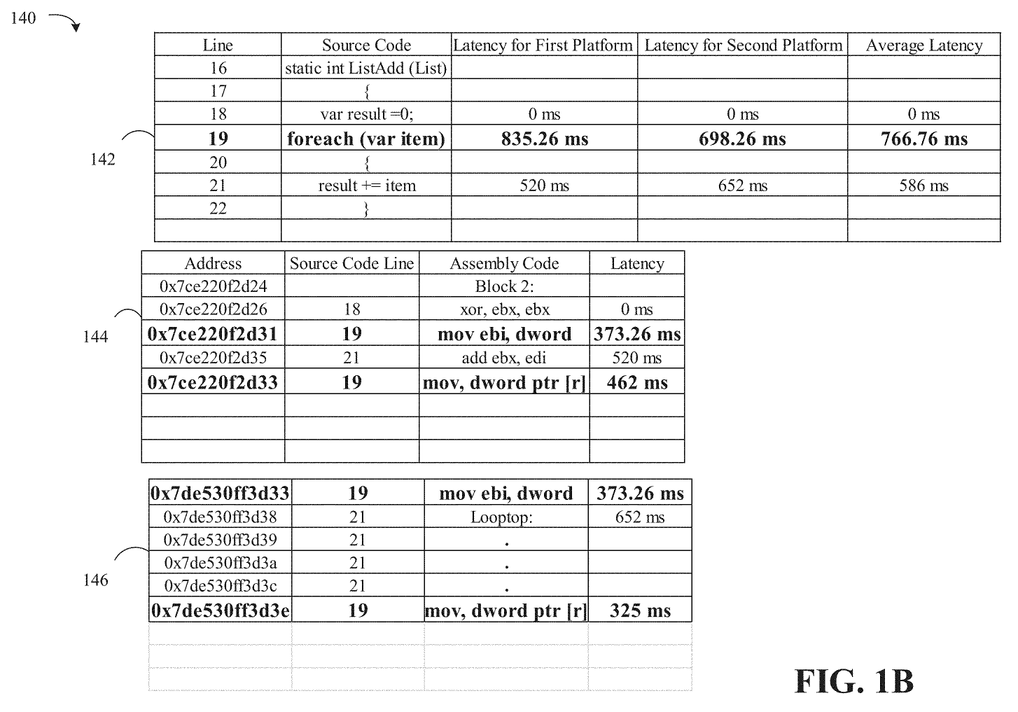

FIG. 2 shows a method 300 that may provide enhanced hotspot analysis to a developer. The method 300 may generally be implemented in a FaaS architecture, such as, for example architecture 100 (FIG. 1), already discussed. In an embodiment, the method 300 is implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 300 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 302 may identify a trigger to analyze source code. The trigger may be a request from a user, an identification of the source code as having a particular importance, if the source code is saved is modified and saved in an IDE, a button actuation in an IDE, an extension/addon to the IDEs which may send the source code/dll to a database on a cloud for analysis, a “new push to the code base” command (e.g., in Github or source control tools that includes extensions to support the command) that sends the source code to the cloud, the event can also be “new dll and pdbs are generated.”

Illustrated processing block 304 may generate a first low-level language code (e.g., a first assembly code) that corresponds to the source code. For example, illustrated processing block 304 may compile the source code into an intermediate language code, and then generate the first assembly code. In some embodiments, the compiler may compile the source code into the first assembly code. In the embodiments, the compiler may generate a symbolic database that indicates that relationship between the source code and the first assembly code.

Illustrated processing block 306 may profile the first low-level language code to identify a first latency of a first portion of the first low-level language code. The profiling may include executing the first low-level language code and timing a total execution of each portion of the first low-level language code until completion.

Illustrated processing block 308 may map the first latency to a source portion of the source code. For example, block 308 may reference the symbolic database to determine that the portion of the first low-level language code is an assembly code representation of the source portion. Illustrated processing block 310 may associate the first low-level language code with the source portion based on the first portion being mapped to the source portion.

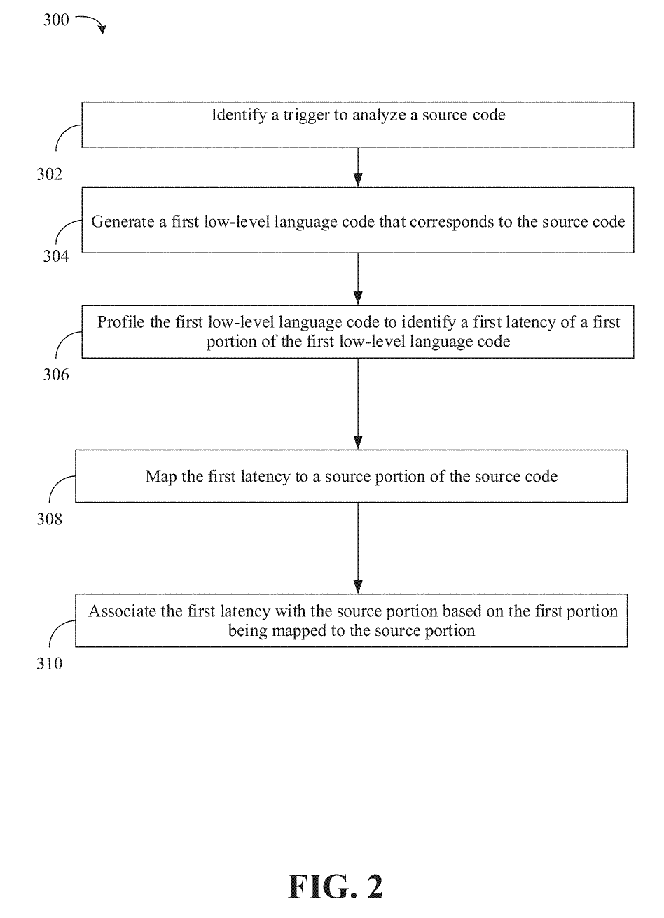

FIG. 3 shows a method 400 of managing source code analysis. The method 400 may generally be implemented in a system architecture such as, for example, the architecture 100 (FIG. 1), already discussed. More particularly, the method 400 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

In the illustrated example, block 402 may detect a source code analysis event (e.g., a trigger to analyze source code). Illustrated processing block 404 may detect whether the source code is compatible with more than one microarchitecture. For example, the source code may be configured to operate on any operating system or computing device. Some source codes may be configured to work on any version of certain mobile phone architectures, and some source codes may be designed for various cloud based architectures. This, block 404 may identify compatible mircoarchitectures. If the source code is compatible with more than one microarchitecture, illustrated processing block 406 may one or more nodes (compute nodes) that have the compatible microarchitectures. Illustrated processing block 408 may obtain user permission to execute on one more of the compatible microarchitectures. In detail, FaaS may include a granular billing system in which a user may be charged per function and/or time. Thus, a user may be consulted to ensure that the user agrees to test the source code across the different compatible microarchitectures. The permission may be set ahead of time (e.g. a blanket permission to execute on any compatible microarchitecture), and/or a user may be queried when the compatible microarchitectures are identified to obtain the permission.

Illustrated processing block 410 may execute a profiler analysis of the source code on each of the one or more microarchitectures that block 408 has obtained permission to execute upon. For example, a first latency may be identified for the source code at a first microarchitecture, and a second latency may be identified for the source code at a second microarchitecture. Illustrated processing block 412 may provide the profiler analysis (e.g., hotspot identification) to the user.

If in processing block 404 the source code is compatible with only one microarchitecture, processing block 414 may execute a profiler analysis on the compatible microarchitecture. Illustrated processing block 416 may provide the profiler analysis (e.g., hotspot identification) to the user.

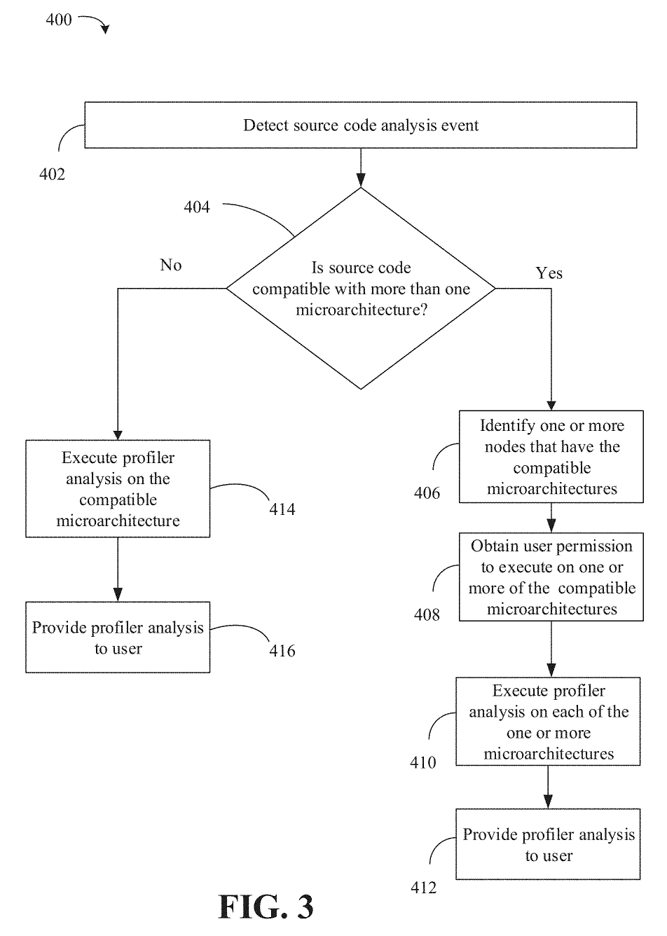

FIG. 4 shows a method 500 of a FaaS source code tuning. The method 500 may generally be implemented in a system architecture such as, for example, the architecture 100 (FIG. 1), already discussed. More particularly, the method 500 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

In the method 500, various processing blocks may be executed by a user device and a cloud (e.g., a FaaS architecture). In FIG. 4, the dashed line indicates the division between the user device and the cloud executions.

In illustrated processing block 502, a user device may trigger a profiling event for an application. Illustrated processing block 504 may be executed by the cloud, and detect the profiling event. Illustrated processing block 506 may trigger functions in response to the detected profiling event. The functions may be profile functions, as described below with respect to illustrated processing block 508.

Processing block 508 may profile the application (e.g., the source code of the application) with functions that invoke performance tools on different microarchitectures. For example, the microarchitectures may be different generations of processors, and/or types of processors. Illustrated processing block 510 may use symbolic resolution to get source-assembly mapping. For example, the source code may be related to the results (latency measurements) of the performance tools through the source-assembly mapping.

Processing block 512 displays performance tuning tips to a programmer based on the source-assembly mapping of the results. Thus, the programmer may identify hotspots in the application and adjust the source code.

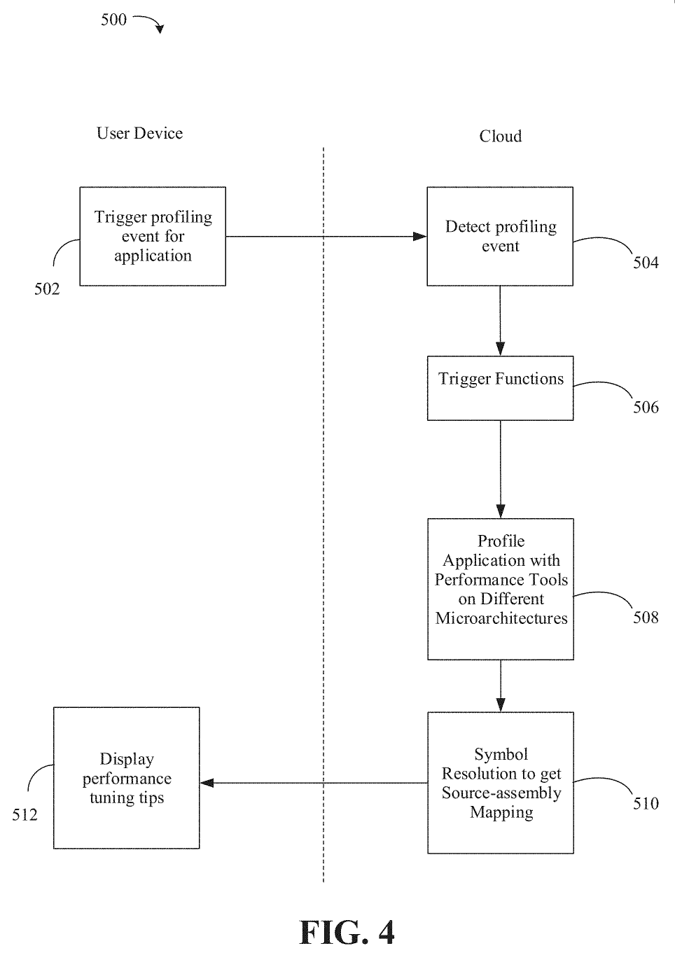

FIG. 5 illustrates a graphical user interface 550 that may be generated by a FaaS architecture to profile source code. In detail, the source file name 552 is displayed. Other designs may only allow a dynamic code (which may not accurately correspond to an original source code) or no code at all to be displayed in the source file column. A symbolic database may be utilized to populate the source file name 552.

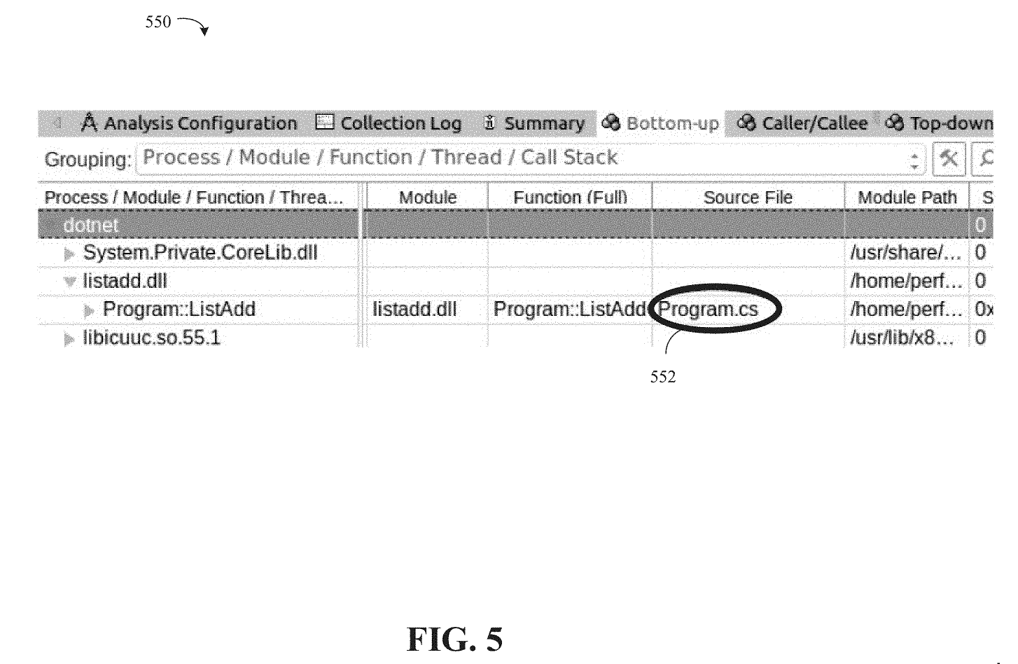

FIG. 6A illustrates a symbolic database 700 that may be generated by a FaaS architecture. The symbolic database may be Portable PDBs to retrieve the source-disassembly mapping information, and be used in combination with sampling information from performance tools (e.g., profilers as described above) to offer performance tuning tips. For example, mapping data 702 for the source-disassembly mapping information may be generated from the metadata root header of the symbolic database 700. The mapping data 702 may include a PDB stream, tables stream and physical tables, strings, US heap, GUID heap and Blob heap.

FIG. 6B illustrates physical tables 704 of the mapping data 702. As illustrated, the physical tables 704 may include a document table and method debug information table. The document table may include source file name(s) to identify the source file(s). The method debug information table may include a source line and IL-to-source map. The IL-to-source map may be determined at compile time of the source file(s). IL may stand for intermediate language (e.g., bytecode). The method debug information table may map the assembly code to source code. For example, the IL-to-source map may indicate a position (commands or sequences of instructions, address lines) in the intermediate language and the corresponding position (line number) in the source code.

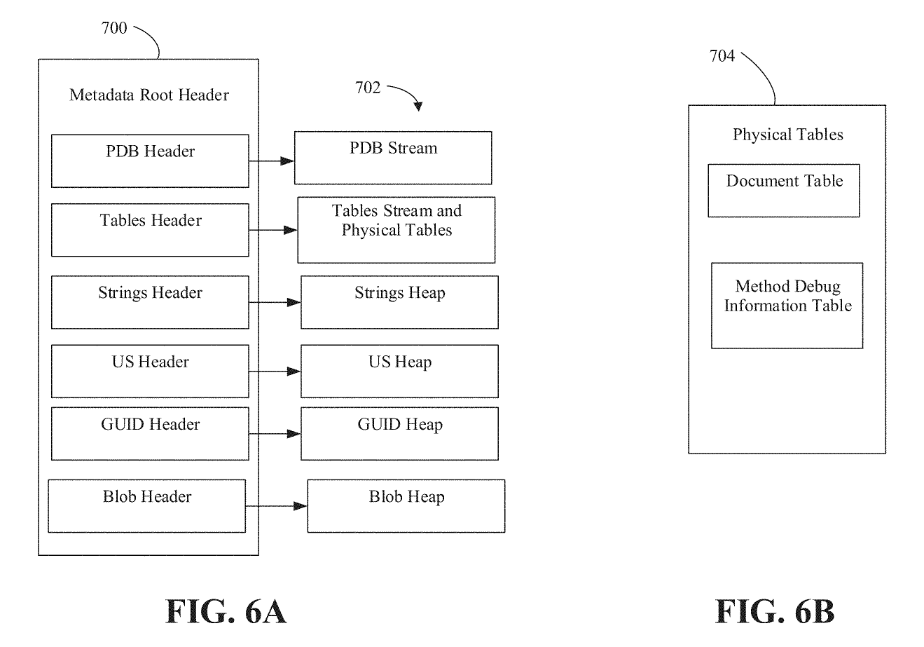

Turning now to FIG. 7, a performance-enhanced profiler computing system 158 is shown. The computing system 158 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), etc., or any combination thereof. In the illustrated example, the system 158 includes a host processor 160 (e.g., CPU with one or more processor cores) having an integrated memory controller (IMC) 162 that is coupled to a system memory 164.

The illustrated system 158 also includes a graphics processor 168 (e.g., graphics processing unit/GPU) and an input output (IO) module 166 implemented together with the processor 160 (e.g., as microcontrollers) on a semiconductor die 170 as a system on chip (SOC), where the IO module 166 may communicate with, for example, a display 172 (e.g., touch screen, liquid crystal display/LCD, light emitting diode/LED display), an input peripheral 156 (e.g., mouse, keyboard, microphone), a network controller 174 (e.g., wired and/or wireless), and mass storage 176 (e.g., HDD, optical disc, SSD, flash memory or other NVM).

A user may provide a source code to the computing system through the network controller 174. In some embodiments, the source code may be provided to the SOC 170 through the input peripheral 156. The SOC 170 may implement instructions stored on, for example, the NVM 176 and/or system memory 164. For example, the host processor 160 may implement instruction stored on the system memory 164 to profile the source code in response to a detected trigger. For example, if the source code is saved, the host processor 160 may automatically profile the source code to determine profiling results such as hotspots of the source code, and link the hotspots to the source code. In some embodiments, the host processor 160 may include two different cores P0, P1. The cores P0, P1 may be heterogeneous (e.g., different generations or types of cores) from each other. The host processor 160 may separately profile the source code on each of the cores P0, P1 to determine hotspots for each respect one of the cores P0, P1. For example, the host processor P0 may profile the source code on core P0 to identify latencies, and separately profile the source code on core P1 to identify latencies. Thus, the host processor 160 may identify whether hotspots are generated by core P0, and/or core P1, and may further average the latencies.

In some embodiments, the host processor 160 may send an instruction through the network controller 174 to a second compute node (e.g., another computing system) to profile the source code. The another compute node may include a SOC that is similar to the SOC 170 above, and a description is omitted for brevity. The SOC 170 may receive a result of the profiling from the second compute node and combine the profiling results to obtain data across different microarchitectures and operating systems. The profiling results may be displayed on the display 172 and/or transmitted to the user through the network controller 174.

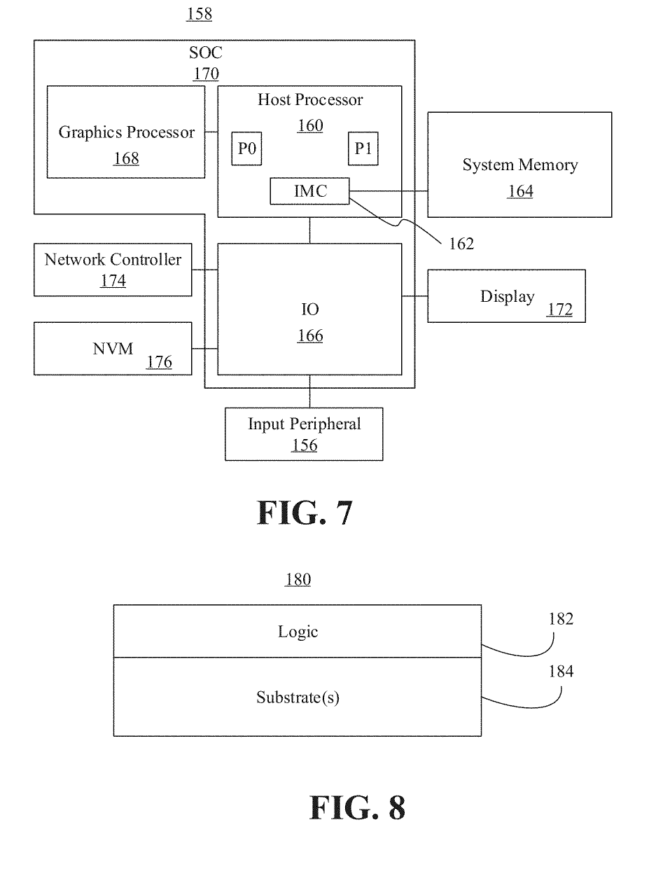

FIG. 8 shows a semiconductor package apparatus 180. The illustrated apparatus 180 includes one or more substrates 184 (e.g., silicon, sapphire, gallium arsenide) and logic 182 (e.g., transistor array and other integrated circuit/IC components) coupled to the substrate(s) 184. In one example, the logic 182 is implemented at least partly in configurable logic or fixed-functionality logic hardware. The logic 182 may implement one or more aspects of the method 300 (FIG. 2), the method 400 (FIG. 3), and/or the method 500 (FIG. 4) already discussed. In some embodiments, the logic 182 may identify a source code to be analyzed, where the source code is a high-level language code, generate a first low-level language code to execute on the first microarchitecture, profile the first low-level language code to identify a first latency of a first portion of the first low-level language code, map the first portion to a source portion of the source code based on an identification that the first portion is a low-level language code representation of the source portion, and associate the first latency with the source portion based on the first portion being mapped to the source portion. In one example, the logic 182 includes transistor channel regions that are positioned (e.g., embedded) within the substrate(s) 184. Thus, the interface between the logic 182 and the substrate(s) 184 may not be an abrupt junction. The logic 182 may also be considered to include an epitaxial layer that is grown on an initial wafer of the substrate(s) 184.

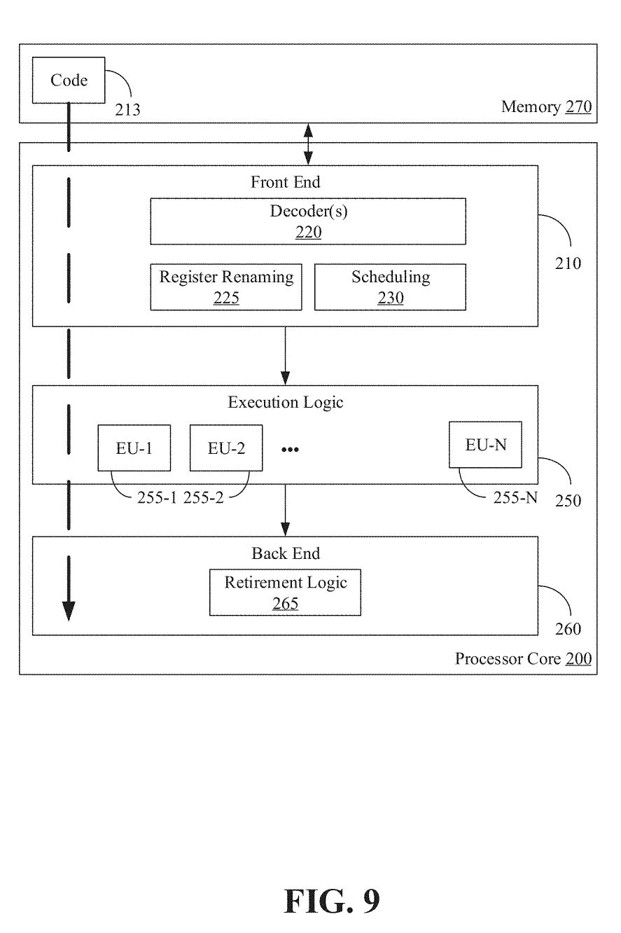

FIG. 9 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 9, a processing element may alternatively include more than one of the processor core 200 illustrated in FIG. 9. The processor core 200 may be a single-threaded core or, for at least one embodiment, the processor core 200 may be multithreaded in that it may include more than one hardware thread context (or “logical processor”) per core.

FIG. 9 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the method 300 (FIG. 2), the method 400 (FIG. 3), and/or the method 500 (FIG. 4) already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 9, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

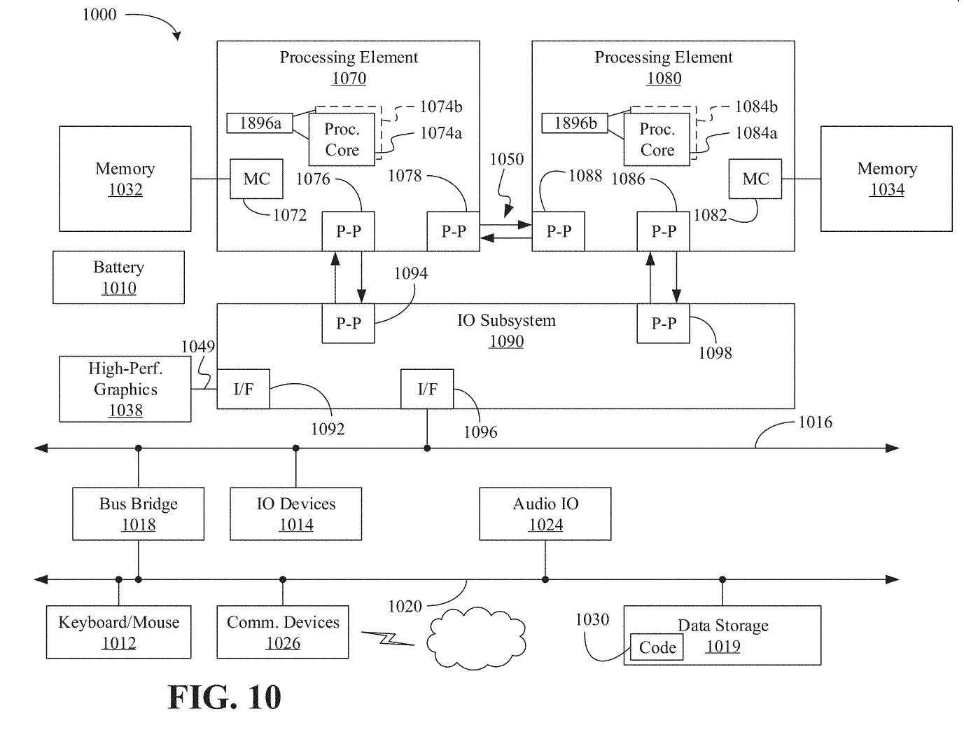

Referring now to FIG. 10, shown is a block diagram of a computing system 1000 embodiment in accordance with an embodiment. Shown in FIG. 10 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 10 may be implemented as a multi-drop bus rather than point-to-point interconnect.

As shown in FIG. 10, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 9.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 10, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 10, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 10, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement one or more aspects of the method 300 (FIG. 2), the method 400 (FIG. 3), and/or the method 500 (FIG. 4) already discussed. Further, an audio I/O 1024 may be coupled to second bus 1020 and a battery 1010 may supply power to the computing system 1000.

Note that other embodiments are contemplated. For example, instead of the point-to-point architecture of FIG. 10, a system may implement a multi-drop bus or another such communication topology. Also, the elements of FIG. 10 may alternatively be partitioned using more or fewer integrated chips than shown in FIG. 10.

### ADDITIONAL NOTES AND EXAMPLES

Example 1 may include one or more compute nodes including a network controller, a first microarchitecture, one or more host processors, and one or more memories coupled to the one or more host processors, the one or more memories including executable program instructions, which when executed by the one or more host processors, cause the one or more compute nodes to profile a first low-level language code to identify a first latency of a first portion of the first low-level language code that is to execute on the first microarchitecture, map the first portion to a source portion of a source code based on an identification that the first portion is a low-level language code representation of the source portion, wherein the source code is a high-level language code, and associate the first latency with the source portion based on the first portion being mapped to the source portion

Example 2 may include the one or more compute nodes of example 1, wherein the one or more compute nodes includes a second microarchitecture different from the first microarchitecture, and the executable program instructions, when executed by the one or more host processors, cause the one or more compute nodes to generate a second low-level language code, wherein the second low-level language code is configured to execute on the second microarchitecture and is a low-level language code representation of the source code.

Example 3 may include the one or more compute nodes of example 2, wherein the executable program instructions, when executed by the one or more host processors, cause the one or more compute nodes to profile the second low-level language code to identify a second latency of a second portion of the second low-level language code, map the second portion to the source portion based on an identification that the second portion is a low-level language code representation of the source portion, and associate the second latency with the source portion based on the second portion being mapped to the source portion.

Example 4 may include the one or more compute nodes of example 3, wherein the executable program instructions, when executed by the one or more host processors, cause the one or more compute nodes to execute the first low-level language code on the first microarchitecture, time the execution of the first low-level language code on the first microarchitecture to identify the first latency, execute the second low-level language code on the second microarchitecture, and time the execution of the second low-level language code on the second microarchitecture to identify the second latency.

Example 5 may include the one or more compute nodes of example 3, wherein the executable program instructions, when executed by the one or more host processors, cause the one or more compute nodes to average the first latency and the second latency to generate an average latency.

Example 6 may include the one or more compute nodes of example 5, wherein the executable program instructions, when executed by the one or more host processors, cause the one or more compute nodes to instruct, with the network controller, a user device to display one or more of the first latency, the second latency or the average latency, instruct, with the network controller, the user device to display the source portion, and instruct, with the network controller, the user device to display a graphical link that indicates an association between the displayed source portion and the displayed one or more of the first latency, the second latency or the average latency.

Example 7 may include a semiconductor apparatus including one or more substrates, and logic coupled to the one or more substrates, wherein the logic is implemented in one or more of configurable logic or fixed-functionality logic hardware, the logic coupled to the one or more substrates to profile a first low-level language code to identify a first latency of a first portion of the first low-level language code, map the first portion to a source portion of a source code based on an identification that the first portion is a low-level language code representation of the source portion, wherein the source code is a high-level language code, and associate the first latency with the source portion based on the first portion being mapped to the source portion

Example 8 may include the apparatus of example 7, wherein the first low-level language code is configured to execute on a first microarchitecture, and the logic coupled to the one or more substrates is to generate a second low-level language code, wherein the second low-level language code is configured to execute on a second microarchitecture different from the first microarchitecture and is a low-level language code representation of the source code.

Example 9 may include the apparatus of example 8, wherein the logic coupled to the one or more substrates is to profile the second low-level language code to identify a second latency of a second portion of the second low-level language code, map the second portion to the source portion based on an identification that the second portion is a low-level language code representation of the source portion, and associate the second latency with the source portion based on the second portion being mapped to the source portion.

Example 10 may include the apparatus of example 9, wherein the logic coupled to the one or more substrates is to execute the first low-level language code on the first microarchitecture, time the execution of the first low-level language code on the first microarchitecture to identify the first latency, execute the second low-level language code on the second microarchitecture, and time the execution of the second low-level language code on the second microarchitecture to identify the second latency.

Example 11 may include the apparatus of example 9, wherein the logic is to average the first latency and the second latency to generate an average latency.

Example 12 may include the apparatus of example 11, wherein the logic is to instruct a user device to display one or more of the first latency, the second latency or the average latency, instruct the user device to display the source portion, and instruct the user device to display a graphical link indicating an association between the displayed source portion and the displayed one or more of the first latency, the second latency or the average latency.

Example 13 may include the apparatus of example 7, wherein the logic coupled to the one or more substrates includes transistor channel regions that are positioned within the one or more substrates.

Example 14 may include at least one computer readable storage medium including a set of instructions, which when executed by one or more compute nodes, cause the one or more compute nodes to profile a first low-level language code to identify a first latency of a first portion of the first low-level language code, map the first portion to a source portion of a source code based on an identification that the first portion is a low-level language code representation of the source portion, wherein the source code is a high-level language code, and associate the first latency with the source portion based on the first portion being mapped to the source portion.

Example 15 may include the at least one computer readable storage medium of example 14, wherein the first low-level language code is configured to execute on a first microarchitecture, and wherein the instructions, when executed, cause the one or more compute nodes to generate a second low-level language code, wherein the second low-level language code is configured to execute on a second microarchitecture different from the first microarchitecture and is a low-level language code representation of the source code.

Example 16 may include the at least one computer readable storage medium of example 15, wherein the instructions, when executed, cause the one or more compute nodes to profile the second low-level language code to identify a second latency of a second portion of the second low-level language code, map the second portion to the source portion based on an identification that the second portion is a low-level language code representation of the source portion, and associate the second latency with the source portion based on the second portion being mapped to the source portion.

Example 17 may include the at least one computer readable storage medium of example 16, wherein the instructions, when executed, cause the one or more compute nodes to execute the first low-level language code on the first microarchitecture, time the execution of the first low-level language code on the first microarchitecture to identify the first latency, execute the second low-level language code on the second microarchitecture, and time the execution of the second low-level language code on the second microarchitecture to identify the second latency.

Example 18 may include the at least one computer readable storage medium of example 16, wherein the instructions, when executed, cause the one or more compute nodes to average the first latency and the second latency to generate an average latency.

Example 19 may include the at least one computer readable storage medium of example 18, wherein the instructions, when executed, cause the one or more compute nodes to instruct a user device to display one or more of the first latency, the second latency or the average latency, instruct the user device to display the source portion, and instruct the user device to display a graphical link indicating an association between the displayed source portion and the displayed one or more of the first latency, the second latency or the average latency.

Example 20 may include a method including profiling a first low-level language code to identify a first latency of a first portion of the first low-level language code, mapping the first portion to a source portion of a source code based on an identification that the first portion is a low-level language code representation of the source portion, wherein the source code is a high-level language code, and associating the first latency with the source portion based on the mapping.

Example 21 may include the method of example 20, wherein the first low-level language code is configured to execute on a first microarchitecture, and the method further includes generating a second low-level language code, wherein the second low-level language code is configured to execute on a second microarchitecture different from the first microarchitecture and is a low-level language code representation of the source code.

Example 22 may include the method of example 21, further including profiling the second low-level language code to identify a second latency of a second portion of the second low-level language code, mapping the second portion to the source portion based on an identification that the second portion is a low-level language code representation of the source portion, and associating the second latency with the source portion based on the second portion being mapped to the source portion.

Example 23 may include the method of example 22, wherein profiling the first low-level language code includes executing the first low-level language code on the first microarchitecture, and timing the execution of the first low-level language code on the first microarchitecture to identify the first latency, and profiling the second low-level language code includes executing the second low-level language code on the second microarchitecture, and timing the execution of the second low-level language code on the second microarchitecture to identify the second latency.

Example 24 may include the method of example 22, further including averaging the first latency and the second latency to generate an average latency.

Example 25 may include the method of example 24, further including instructing a user device to display one or more of the first latency, the second latency or the average latency, instructing the user device to display the source portion, and instructing the user device to display a graphical link indicating an association between the displayed source portion and the displayed one or more of the first latency, the second latency or the average latency.

Example 26 may include a semiconductor apparatus including means for profiling a first low-level language code to identify a first latency of a first portion of the first low-level language code, means for mapping the first portion to a source portion of a source code based on an identification that the first portion is a low-level language code representation of the source portion, wherein the source code is a high-level language code, and means for associating the first latency with the source portion based on the mapping.

Example 27 may include the semiconductor apparatus of example 26, wherein the first low-level language code is to be configured to execute on a first microarchitecture, and the method further includes means for generating a second low-level language code, wherein the second low-level language code is to be configured to execute on a second microarchitecture different from the first microarchitecture and is a low-level language code representation of the source code.

Example 28 may include the semiconductor apparatus of example 27, further including means for profiling the second low-level language code to identify a second latency of a second portion of the second low-level language code, means for mapping the second portion to the source portion based on an identification that the second portion is a low-level language code representation of the source portion, and means for associating the second latency with the source portion based on the second portion being mapped to the source portion.

Example 29 may include the semiconductor apparatus of example 28, wherein the means for profiling the first low-level language code includes means for executing the first low-level language code on the first microarchitecture, and means for timing the execution of the first low-level language code on the first microarchitecture to identify the first latency, and the means for profiling the second low-level language code includes means for executing the second low-level language code on the second microarchitecture, and means for timing the execution of the second low-level language code on the second microarchitecture to identify the second latency.

Example 30 may include the semiconductor apparatus of example 28, further including means for averaging the first latency and the second latency to generate an average latency.

Example 31 may include the semiconductor apparatus of example 30, further including means for instructing a user device to display one or more of the first latency, the second latency or the average latency, means for instructing the user device to display the source portion, and means for instructing the user device to display a graphical link indicating an association between the displayed source portion and the displayed one or more of the first latency, the second latency or the average latency.

Thus, technology described herein may support source code analysis that previously was not enabled. For example, the technology may allow for enhanced mapping of source code to assembly code to identify hotspots of the source code. Moreover, the technology may allow the source code to be analyzed across a series of different platforms with different microarchitectures to generate a more accurate latency analysis on a global implementation of the source code.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SOCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. One or more compute nodes comprising:
a network controller;
a first microarchitecture;
one or more host processors; and
one or more memories coupled to the one or more host processors, the one or more memories including executable program instructions, which when executed by the one or more host processors, cause the one or more compute nodes to:
profile a first low-level language code to identify a first latency of a first portion of the first low-level language code that is to execute on the first microarchitecture;
map the first portion to a source portion of a source code based on an identification that the first portion is a low-level language code representation of the source portion, wherein the source code is a high-level language code; and
associate the first latency with the source portion based on the first portion being mapped to the source portion.

2. The one or more compute nodes of claim 1, wherein:
the one or more compute nodes includes a second microarchitecture different from the first microarchitecture;
the executable program instructions, when executed by the one or more host processors, cause the one or more compute nodes to generate a second low-level language code, wherein the second low-level language code is configured to execute on the second microarchitecture and is a low-level language code representation of the source code.

3. The one or more compute nodes of claim 2, wherein the executable program instructions, when executed by the one or more host processors, cause the one or more compute nodes to:
profile the second low-level language code to identify a second latency of a second portion of the second low-level language code;
map the second portion to the source portion based on an identification that the second portion is a low-level language code representation of the source portion; and
associate the second latency with the source portion based on the second portion being mapped to the source portion.

4. The one or more compute nodes of claim 3, wherein the executable program instructions, when executed by the one or more host processors, cause the one or more compute nodes to:
execute the first low-level language code on the first microarchitecture;
time the execution of the first low-level language code on the first microarchitecture to identify the first latency;
execute the second low-level language code on the second microarchitecture; and
time the execution of the second low-level language code on the second microarchitecture to identify the second latency.

5. The one or more compute nodes of claim 3, wherein the executable program instructions, when executed by the one or more host processors, cause the one or more compute nodes to:
average the first latency and the second latency to generate an average latency.

6. The one or more compute nodes of claim 5, wherein the executable program instructions, when executed by the one or more host processors, cause the one or more compute nodes to:
instruct, with the network controller, a user device to display one or more of the first latency, the second latency or the average latency;
instruct, with the network controller, the user device to display the source portion; and
instruct, with the network controller, the user device to display a graphical link that indicates an association between the displayed source portion and the displayed one or more of the first latency, the second latency or the average latency.

7. A semiconductor apparatus comprising:
one or more substrates; and
logic coupled to the one or more substrates, wherein the logic is implemented in one or more of configurable logic or fixed-functionality logic hardware, the logic coupled to the one or more substrates to:
profile a first low-level language code to identify a first latency of a first portion of the first low-level language code;
map the first portion to a source portion of a source code based on an identification that the first portion is a low-level language code representation of the source portion, wherein the source code is a high-level language code; and
associate the first latency with the source portion based on the first portion being mapped to the source portion.

8. The apparatus of claim 7, wherein the first low-level language code is configured to execute on a first microarchitecture; and
the logic coupled to the one or more substrates is to:
generate a second low-level language code, wherein the second low-level language code is configured to execute on a second microarchitecture different from the first microarchitecture and is a low-level language code representation of the source code.

9. The apparatus of claim 8, wherein the logic coupled to the one or more substrates is to:
profile the second low-level language code to identify a second latency of a second portion of the second low-level language code;
map the second portion to the source portion based on an identification that the second portion is a low-level language code representation of the source portion; and
associate the second latency with the source portion based on the second portion being mapped to the source portion.

10. The apparatus of claim 9, wherein the logic coupled to the one or more substrates is to:
execute the first low-level language code on the first microarchitecture;
time the execution of the first low-level language code on the first microarchitecture to identify the first latency;
execute the second low-level language code on the second microarchitecture; and
time the execution of the second low-level language code on the second microarchitecture to identify the second latency.

11. The apparatus of claim 9, wherein the logic is to average the first latency and the second latency to generate an average latency.

12. The apparatus of claim 11, wherein the logic is to:
instruct a user device to display one or more of the first latency, the second latency or the average latency;
instruct the user device to display the source portion; and
instruct the user device to display a graphical link indicating an association between the displayed source portion and the displayed one or more of the first latency, the second latency or the average latency.

13. The apparatus of claim 7, wherein the logic coupled to the one or more substrates includes transistor channel regions that are positioned within the one or more substrates.

14. At least one computer readable storage medium comprising a set of instructions, which when executed by one or more compute nodes, cause the one or more compute nodes to:
profile a first low-level language code to identify a first latency of a first portion of the first low-level language code;
map the first portion to a source portion of a source code based on an identification that the first portion is a low-level language code representation of the source portion, wherein the source code is a high-level language code; and
associate the first latency with the source portion based on the first portion being mapped to the source portion.

15. The at least one computer readable storage medium of claim 14, wherein the first low-level language code is configured to execute on a first microarchitecture; and
wherein the instructions, when executed, cause the one or more compute nodes to generate a second low-level language code, wherein the second low-level language code is configured to execute on a second microarchitecture different from the first microarchitecture and is a low-level language code representation of the source code.

16. The at least one computer readable storage medium of claim 15, wherein the instructions, when executed, cause the one or more compute nodes to:
profile the second low-level language code to identify a second latency of a second portion of the second low-level language code;
map the second portion to the source portion based on an identification that the second portion is a low-level language code representation of the source portion; and
associate the second latency with the source portion based on the second portion being mapped to the source portion.

17. The at least one computer readable storage medium of claim 16, wherein the instructions, when executed, cause the one or more compute nodes to:
execute the first low-level language code on the first microarchitecture;
time the execution of the first low-level language code on the first microarchitecture to identify the first latency;
execute the second low-level language code on the second microarchitecture; and
time the execution of the second low-level language code on the second microarchitecture to identify the second latency.

18. The at least one computer readable storage medium of claim 16, wherein the instructions, when executed, cause the one or more compute nodes to average the first latency and the second latency to generate an average latency.

19. The at least one computer readable storage medium of claim 18, wherein the instructions, when executed, cause the one or more compute nodes to:
instruct a user device to display one or more of the first latency, the second latency or the average latency;
instruct the user device to display the source portion; and
instruct the user device to display a graphical link indicating an association between the displayed source portion and the displayed one or more of the first latency, the second latency or the average latency.

20. A method comprising:
profiling a first low-level language code to identify a first latency of a first portion of the first low-level language code;
mapping the first portion to a source portion of a source code based on an identification that the first portion is a low-level language code representation of the source portion, wherein the source code is a high-level language code; and
associating the first latency with the source portion based on the mapping.

21. The method of claim 20, wherein:
the first low-level language code is configured to execute on a first microarchitecture; and
the method further comprises:
generating a second low-level language code, wherein the second low-level language code is configured to execute on a second microarchitecture different from the first microarchitecture and is a low-level language code representation of the source code.

22. The method of claim 21, further comprising:
profiling the second low-level language code to identify a second latency of a second portion of the second low-level language code;
mapping the second portion to the source portion based on an identification that the second portion is a low-level language code representation of the source portion; and
associating the second latency with the source portion based on the second portion being mapped to the source portion.

23. The method of claim 22, wherein:
profiling the first low-level language code includes:
executing the first low-level language code on the first microarchitecture; and
timing the execution of the first low-level language code on the first microarchitecture to identify the first latency;
profiling the second low-level language code includes:
executing the second low-level language code on the second microarchitecture; and
timing the execution of the second low-level language code on the second microarchitecture to identify the second latency.

24. The method of claim 22, further comprising:
averaging the first latency and the second latency to generate an average latency.

25. The method of claim 24, further comprising:
instructing a user device to display one or more of the first latency, the second latency or the average latency;
instructing the user device to display the source portion; and
instructing the user device to display a graphical link indicating an association between the displayed source portion and the displayed one or more of the first latency, the second latency or the average latency.
